(19) United States
(12) Patent Application Publication
(10) Pub. No.: US 2009/0197583 A1
(43) Pub. Date: Aug. 6, 2009

(54) Apparatus and Method for Providing Visual Information Identifying a Stored Voicemail

(76) Inventors: Raymond Penn, Davie, FL (US); Michael Self, Fort Lauderdale, FL (US); Jonathan Hollander, Hewlett, NY (US)

Correspondence Address: ROBERT M. SCHWARTZ, P.A., P.O. BOX 221470, HOLLYWOOD, FL, 33022, US

(21) Appl. No.: 12/361,564

(22) Filed: Jan. 29, 2009

Related U.S. Application Data
(60) Provisional application No. 61/024,651, filed on Jan. 30, 2008.

(51) Int. Cl. H04M 3/42; G06F 17/00

(52) U.S. Cl. 455/415; 715/200

(57) ABSTRACT

A system and method are provided for generating a visual display of information identifying the origin of a voicemail message targeted at a particular user. The visual display is presented to the user on the screen of the user's mobile device or handset. At least a portion of the information identifying the origin of the voicemail is captured from information sent with the telephone call when the call is placed.

### INDEX TO RELATED APPLICATIONS

This application claims the benefit of U.S. Provisional Patent Application 61/024,651, filed Jan. 30, 2008, the disclosure of which is incorporated herein by reference in its entirety.

### BACKGROUND OF THE INVENTION

1. Field of the Invention

The invention relates to an apparatus and method of providing graphical and/or textual information identifying a stored voicemail, and more particularly for providing visual information identifying a stored voicemail to a mobile device.

2. Description of the Related Art

At present, there exist numerous mobile devices that can display visual information on their display screens. For example, it is known to view received emails on certain mobile devices, such as PDAs, Pocket PCs, smartpagers and smartphones. Additionally, U.S. Pat. Nos. 5,283,818 and 5,572,576 to Klausner et al., disclose a telephone answering device linking displayed data with a recorded audio message. The Klausner et al., references disclose a system wherein codes or numbers entered into the telephone by the caller are recognized, recorded and processed by the telephone answering device. When processed with codes and personal information previously entered into the memory of the telephone answering device, the device of Klausner et al., displays the identity of the callers for each message, thus providing a menu of choices, i.e., a list of callers, that enables the user to access messages in a selective manner based on the identity of the caller.

More recently, “visual voicemail” applications have emerged wherein users selectively pick which messages to listen to via a visual display on a mobile device. The IPHONE by APPLE Inc., is one such mobile device that provides onscreen information related to received voicemails. As with Klausner et al., the IPHONE and other similar devices generate the visual information associated with the voicemail using personal information previously entered into the memory of the device.

What is needed is a system and method of generating and storing information identifying a voicemail without the need for the user to enter such identifying information into the memory of the device.

### SUMMARY OF THE INVENTION

It is accordingly an object of the invention to provide a system and method for generating a visual display of information identifying the origin of a voicemail message targeted at a particular user, wherein the visual display is presented to the user on the screen of the user's mobile device or handset. At least a portion of the information identifying the origin of the voicemail is captured from information sent with the telephone call when the call is placed. Other features which are considered as characteristic for the invention are set forth in the appended claims.

Although the invention is illustrated and described herein as embodied in an Apparatus and Method for Providing Visual Information Identifying a Stored Voicemail, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE DRAWINGS

FIG. 1 is a block diagram of system in accordance with one particular embodiment of the present invention.

FIG. 2 is a partial isometric view of the screen of a mobile device showing one particular exemplary graphical representation of a visual display showing a plurality of voicemails stored on the mobile device and each voicemail's associated identifying information.

### DESCRIPTION OF THE PREFERRED EMBODIMENTS

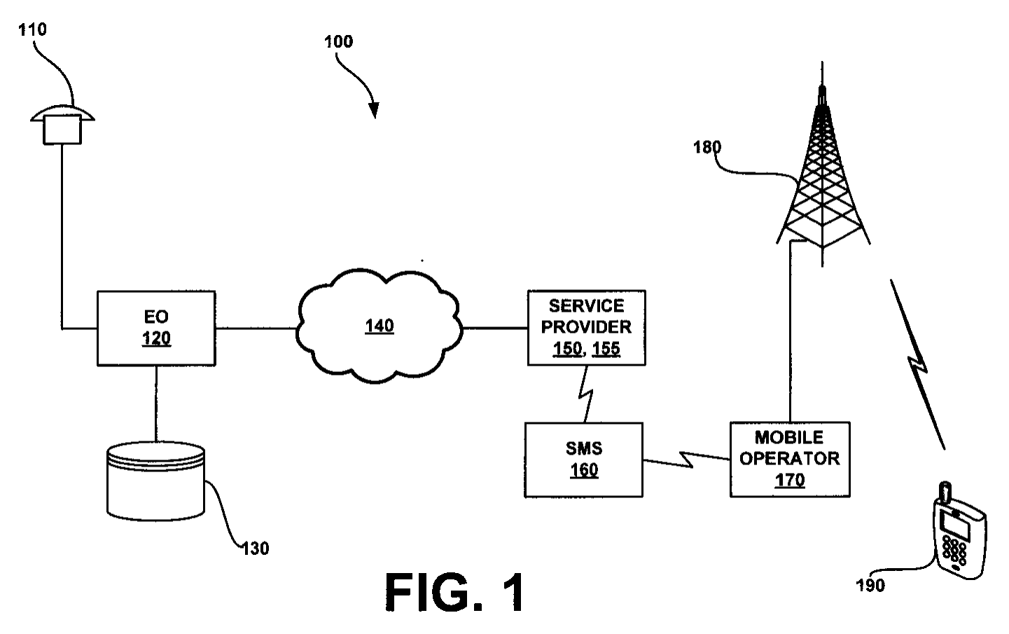

Referring now to the figures of the drawing in detail and first, particularly, to FIG. 1 thereof, there is shown a block diagram of a system 100 for providing a visual display of identifying information for a voicemail stored on a mobile device 190. More particularly, a call is placed by a caller on a handset or telephone 110. The call is passed through an end office (EO) 120 wherein additional data is appended to the signal. As shown in FIG. 1, each end office 120 includes a database 130 in which is stored caller identification (CID) information, such as the calling number delivery (CND) information and calling name delivery (CNAM) information for the handset/location originating the call. Upon origination of the call, and prior to the call being answered, the end office 120 appends the CND information and/or CNAM information to the call signal. CND information includes the telephone number of the originating handset/location, while CNAM information includes textual data representing a user name associated with the originating handset/location. In accordance with present industry standards, the CNAM information stored in association with a handset/location is typically 15 characters in length.

As stated above, an end office 120 will append identifying information to a call originated through the end office 120. The call signal, with the CID information appended thereto, can then be routed through a communications network, such as a public switched telephone network (PSTN) 140. Note that other communications networks, such as satellite, cellular, computer, etc., and combinations thereof, can be used with and/or instead of a PSTN communications network.

As stated above, the communications network routes the call to the service provider 150 for the targeted receiving mobile handset 190. In the event that the user of the targeted mobile handset 190 does not answer the call in a predetermined amount of time or is otherwise unavailable (including but not limited to if the mobile handset 190 is turned off or has no coverage), or the mobile handset 190 is otherwise instructed to forward the call, the originating caller may then be connected to a voicemail system of a voicemail service provider 155 which may or may not be the same as the service provider 150, wherein the originating caller leaves a voice message for the targeted user. In addition to storing the voice message from the originating caller, the voice mail service provider 155 captures and stores the CID (i.e., CNAM and/or CND) information transmitted with the call.

In the instant invention, the voice message is downloaded to the targeted mobile handset or mobile device 190. Additionally, in the present embodiment of the invention the voice mail service provider 155 sends an SMS message 160 including at least the captured CNAM information and the telephone number of the originating handset/location. The SMS message 160 and/or the packetized voicemail message can be provided to the operator of the mobile network 170 to which the targeted mobile handset 190 belongs by any number of known methods, including, the internet, a WAP gateway and/or a WAN. The SMS message 160 and packetized voicemail are then provided by the mobile operator 170 to the targeted user or mobile device/handset 190 via a second communications network 180, which can be a mobile communications network, such as GSM, UMTS, CDMA, iDEN, etc.

As such, the present invention provides the targeted call recipient with information identifying the caller associated with a voicemail. This permits the user to selectively listen to individual voicemails based on, among other criteria, the identity of the caller, without requiring the user to enter personal information of potential callers into the memory of the mobile handset 190.

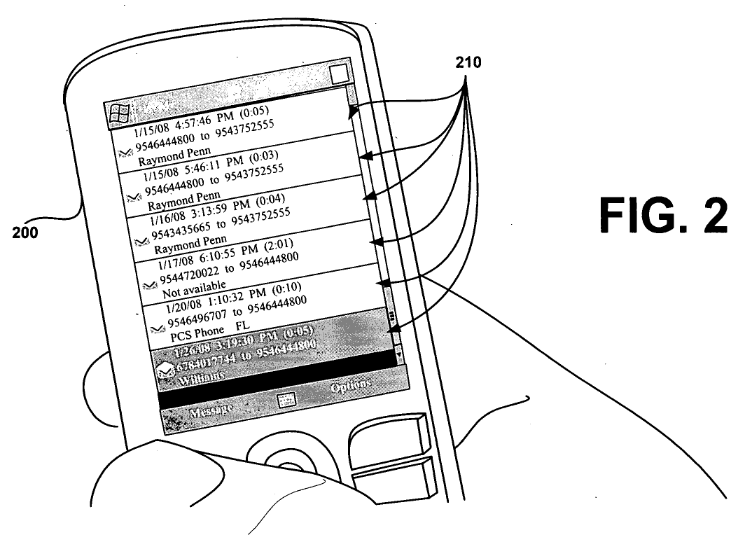

Additionally, in one particular embodiment of the present invention, additional information is displayed on the mobile device 190 in connection with a stored voicemail. Referring now to FIG. 2, there is shown a mobile device 200 in accordance with the present embodiment, including a plurality of voicemails 210 stored thereon. However, in the present embodiment, a portion of the information displayed in connection with a stored voicemail is obtained from the signal originating with the call, while another portion of the information is generated by the mobile device.

For example, in the present particular embodiment of the invention, the name of the caller and the telephone number of the handset originating the call are obtained from the CID is information. Additionally, each entry shown in the voicemail log includes additional information, such as the duration of the voicemail, the date and time that the voicemail was originally recorded and, in one particular embodiment, the telephone number called by the originating caller. Providing the user with the telephone number that was called is useful in systems wherein the user has several phone numbers that can be linked/call forwarded to the mobile device 200. Note that, in such a system, the originating caller is targeting the user, and not necessarily the particular mobile device that ultimately receives the voicemail. Providing the phone number of the targeted user with the voicemail allows the user to make a determination of whether to listen to a particular message based on, among other information, the telephone number at which the caller tried to reach the user.

In the present embodiment of the invention, some or all of the additional information can be generated by the voice mail service provider and sent with the SMS message or, alternately, can be generated at the mobile handset. In one particular preferred embodiment, the SMS message provided by the service provider to the mobile device includes, at least: (1) the CNAM and number of the originating handset (i.e. CND and/or CID information) captured from the call signal; (2) the duration of the stored voicemail; (3) the date and time that the voicemail was stored at the service provider; and (4) the number called by the originating handset/location. However, if desired, at least the time and/or the date of the voicemail can be generated by the mobile device based on the internal clock of the mobile device and/or the clock signals of the mobile network transmitted with the SMS message.

While the invention has been described with reference to certain embodiments, it will be understood by those skilled in the art that various changes may be made and equivalents may be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

I claim:

1. A system for providing identifying information associated with a voicemail for visual display on a mobile device, comprising:
a calling device from which a call originates;
a first processor in communication with said calling device and located remotely from said calling device, said first processor appending identifying information associated with the calling device, including at least a name associated with the calling device, to a signal representing a call placed from the calling device;
a second processor located remotely from said first processor, for receiving said signal and extracting the appended identifying information;
a computer associated with the second processor for storing a voicemail message sent from said calling device, said computer configured to provide said voicemail message and said extracted appended identifying information to a mobile communications network; and
a third processor located in the mobile device for receiving said voicemail message and said extracted appended identifying information from the mobile communications network and for formatting the extracted appended identifying information for display on the mobile device.
